(19) United States
(12) Patent Application Publication
(10) Pub. No.: US 2011/0066569 A1
(43) Pub. Date: Mar. 17, 2011

(54) ALLOCATION OF A CREDIT DEFAULT SWAP PORTFOLIO

(76) Inventors: Ketan Patel, Hanover Park, IL (US); Muhammed Hadi, Chicago, IL (US); Amy McCormick, Chicago, IL (US); Ankeet Dedhia, Chicago, IL (US)

(21) Appl. No.: 12/560,095

(22) Filed: Sep. 15, 2009

(51) Int. Cl. G06Q 40/00

(52) U.S. Cl. 705/36 R

(57) ABSTRACT

A method for allocating margin of a credit default swap portfolio is provided. The method includes identifying a credit default swap portfolio maintained by a defaulting clearing firm, determining a defaulting margin for the portfolio, the defaulting margin being determined using a margin model; and allocating the defaulting margin to one or more non-defaulting clearing firms based on account margins for each of the non-defaulting clearing firms.

### FIELD

The present embodiments relate to allocation of a credit default swap portfolio.

### BACKGROUND

Exchanges provide market access through clearing firms, such as futures commission merchants (FCM). Clearing firms are organizations that work with an exchange's clearing house to handle confirmation, delivery, and settlement of transactions, such as orders to buy and/or sell future contracts or options on futures. Clearing firms ensure that executed trades are settled within a specified period of time and are generally independent intermediaries that specialize in clearing trades for brokers/dealers through the exchange-run clearing house. Clearing firms may be member firms of the exchange's clearing house and may be authorized to clear trades for its broker/dealer customers who are exchange members but not necessarily members of the exchanges clearing house.

In the event that a clearing member defaults, i.e., is bankrupt or insolvent, the exchange's clearing house may attempt to sell the defaulting member's portfolio of credit default swaps in order to allocate risk. A credit default swap is a swap designed to transfer the credit exposure between parties. For example, the buyer of a credit swap receives credit protection (i.e., bought protection), whereas the seller of the swap guarantees the credit worthiness of the product (i.e., write protection). Other clearing members may choose to purchase all, some, or none of the defaulting member's portfolio of credit default swaps.

The credit default swaps that are not purchased, i.e., the illiquid credit default swaps, need to be distributed or absorbed in order to ensure market security.

### BRIEF DESCRIPTION OF THE DRAWINGS

FIG. 1 illustrates one embodiment of an exchange system;

FIG. 2 illustrates one embodiment of a exchange computer system;

FIG. 3 illustrates one embodiment of a total portfolio margin of a defaulting clearing member;

FIG. 4 illustrates one embodiment of weights for each clearing firm;

FIG. 5 illustrates one embodiment of an aggregate margin;

FIG. 6 illustrates one embodiment of an allocated margin;

FIG. 7 illustrates one embodiment of a method for determining an allocated margin;

FIG. 8 illustrates one embodiment of a method for determining a margin weight; and

FIG. 9 illustrates one embodiment of a method for determining an operating income weight.

### DETAILED DESCRIPTION

The present embodiments relate to allocation of a credit default swap portfolio. The portfolio may be allocated when a clearing firm defaults, i.e., goes bankrupt. The credit default swap portfolio may be allocated to non-defaulting clearing firms based on the size of the non-defaulting firm's portfolio, for example, relative to the portfolios of all the clearing firms. As a result, the risk of absorbing the defaulting portfolio may be absorbed among the non-defaulting firms in such a way that the distribution of the risk is fair and equitable to the non-defaulting firms.

As used herein, a credit default swap (CDS) transfers the credit exposure (read risk) of fixed income products between parties. A credit default swap is a credit derivative contract between two counterparties. The buyer makes periodic payments to the seller, and in return receives a payoff if an underlying financial instrument defaults. The buyer of a credit swap receives credit protection. The seller of the swap guarantees the credit worthiness of the product. By doing this, the risk of default is transferred from the holder of the fixed income security to the seller of the swap. The buyer of a credit swap will be entitled to the par value of the bond by the seller of the swap, for example, if the bond defaults in its coupon payments.

In one aspect, a method for allocating margin of a defaulting firm is provided. The method may include determining, using a computer exchange system, a total weight for a non-defaulting clearing firm. The non-defaulting clearing firm may maintain credit default swap portfolios. The method may further include determining an aggregated margin and determining an allocated margin of the margin of the defaulting firm for the non-defaulting clearing firm as a function of the total weight and aggregated margin.

In a second aspect, an exchange system is provided. The exchange system includes a processor and a memory coupled with the processor. The memory includes instructions that are operable to be executed to determine a total weight for a non-defaulting clearing firm, the non-defaulting clearing firm maintaining credit default swap portfolios; determine, using the computer exchange system, an aggregated margin; and determine an allocated margin of the margin of the defaulting firm for the non-defaulting clearing firm as a function of the total weight and aggregated margin.

In a third aspect, a system for allocating margin for a credit default swap portfolio is provided. The system includes a means for determining a total weight for a non-defaulting clearing firm, the non-defaulting clearing firm maintaining credit default swap portfolios; a means for determining an aggregated margin; and a means for determining an allocated margin of the margin of the defaulting firm for the non-defaulting clearing firm as a function of the total weight and aggregated margin.

In a fourth aspect, a method for allocating margin of a credit default swap portfolio is provided. The method includes identifying a credit default swap portfolio maintained by a defaulting clearing firm, determining a defaulting margin for the portfolio, the defaulting margin being determined using a margin model, and allocating the defaulting margin to one or more non-defaulting clearing firms based on account margins for each of the non-defaulting clearing firms.

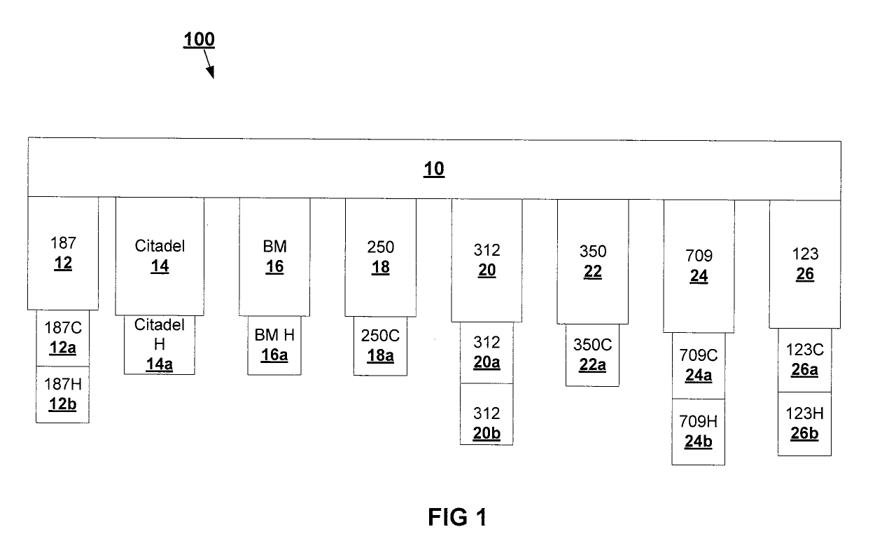

FIG. 1 illustrates an exchange system 100. The exchange system 100 includes an exchange computer system 10 and one or more clearing firms 12, 14, 16, 18, 20, 22, 24, 26. The exchange system 100 may include additional, different, or fewer components. Clearing firms 12, 14, 16, 18, 20, 22, 24, 26 may be futures commission merchants (FCM) or other organizations that work with the exchange's clearing house to handle confirmation, delivery, and settlement of transactions, such as orders to buy and/or sell future contracts or options on futures. Clearing firms 12, 14, 16, 18, 20, 22, 24, 26 ensure that executed trades are settled within a specified period of time and are generally independent intermediaries that specialize in clearing trades for brokers/dealers through the exchange-run clearing house. Clearing firms 12, 14, 16, 18, 20, 22, 24, 26 may be member firms of the exchange's clearing house and so are authorized to clear trades for its broker/dealer customers who are exchange members but not necessarily members of the exchanges clearing house.

Clearing firms 12, 14, 16, 18, 20, 22, 24, 26 may provide credit protection to customers. Credit protection may include write protection and/or bought protection. As used herein, write protection relates to the guarantee of protection against a credit event, such as a default. Bought protection relates to the buying of protection against a default event. The credit protection may be included in a credit default swap portfolio, as discussed below.

The clearing firms 12, 14, 16, 18, 20, 22, 24, 26 may own, operate, manage, control, or monitor one or more accounts 12a, 12b, 14a, 16a, 18a, 20a, 20b, 22a, 24a, 24b, 26a, 26b. The one or more accounts may include house accounts 12b, 14a, 16a, 20b 24a, 26b; customer accounts 12a, 18a, 20a, 22a, 24a, 26a; or a combination thereof. The house accounts may include the clearing firm's credit default swap portfolio, for example, traded by the clearing firm. As shown in FIG. 1, the house accounts are illustrated with an “H.” The one or more accounts may be customer accounts 12a, 18a, 20a, 22a, 24a, 26a. The customer accounts may include customer's credit default swap portfolio, for example, traded by customers. The clearing firm may provide market access to the customers. The customer accounts are illustrated with a “C.”

Clearing firms 12, 14, 16, 18, 20, 22, 24, 26 may default when the clearing firm is unwilling or unable to pay a clearing firm debt, fails to pay back a loan, or does not satisfy a legal obligation. For example, clearing firm 18a may default when a customer is declared bankrupt. The customer may be a majority of the clearing firm's 18a business. Without the customer, the clearing firm 18a may be unable to satisfy legal obligations.

In one illustration, which will be referred to herein as the “illustration above,” clearing firm 26 defaults, i.e., is bankrupt or insolvent. At the time of default, clearing firm 26 may own a credit default swap portfolio having write protection and/or bought protection. The exchange computer system 10 may be used to allocate the credit default swap portfolio to the non-defaulting clearing firms 12, 14, 16, 18, 20, 22, 24.

The exchange computer system 10 may be owned, managed, controlled, monitored, programmed, sold, or used by an exchange. The exchanges may be a regulated or unregulated exchange or other electronic trading service making use of electronic trading systems. For example, the exchange may include the Chicago Board of Trade (CBOT), the Chicago Mercantile Exchange (CME), the Bolsa de Mercadorias e Futoros in Brazil (BMF), the London International Financial Futures Exchange, the New York Mercantile Exchange (NYMEX), the Kansas City Board of Trade (KCBT), MATIF (in Paris, France), the London Metal Exchange (LME), the Tokyo International Financial Futures Exchange, the Tokyo Commodity Exchange for Industry (TOCOM), the Meff Renta Variable (in Spain), the Dubai Mercantile Exchange (DME), and the Intercontinental Exchange (ICE).

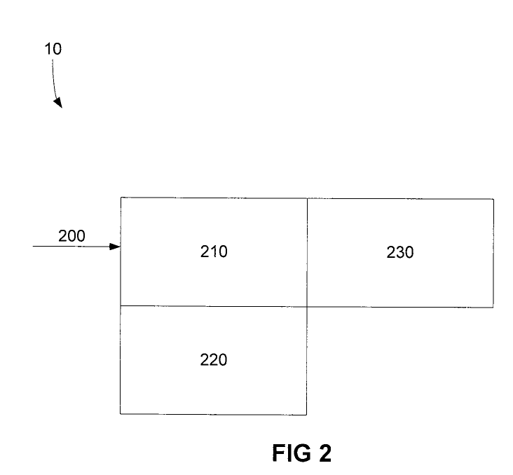

FIG. 2 illustrates one embodiment of an exchange computer system 10. The exchange computer system 10 may include an input 200, a processor 210, a memory 220, and an output 230. The processor 210 may be coupled with the input 200, memory 220, and/or output 230. As used herein, “coupled with” may include directly connected or indirectly connected through one or more intermediary components. Intermediary components may include hardware and/or software components.

The input 200 may be a user input, network interface, external storage, or other input device for providing data to the system 100. For example, the input 200 is a mouse, keyboard, track ball, touch screen, joystick, touch pad, buttons, knobs, sliders, combinations thereof, or other now known or later developed user input device. The user input may operate as part of a user interface. For example, one or more buttons are displayed on the output 230. The user input is used to control a pointer for selection and activation of the functions associated with the buttons. Alternatively, hard coded or fixed buttons may be used. As another example, the input 200 is a hard-wired or wireless network interface. A universal asynchronous receiver/transmitter (UART), a parallel digital interface, a software interface, Ethernet, or any combination of known or later developed software and hardware interfaces may be used. The network interface may be linked to various types of networks, including a local area network (LAN), a wide area network (WAN), an intranet, a virtual private network (VPN), and the Internet. The input 200 may be used to access, receive, or otherwise obtain data stored in memory 220.

The input 200 is an interface to receive data. The data may include margin data. Margin data may include data relating to the margin of one or more defaulting and/or non-defaulting clearing firms 12, 14, 16, 18, 20, 22, 24, 26. As used herein, margin relates to collateral that the clearing firms deposit with the exchange to cover the credit risk of the counterparty. Collateral may be in the form of cash or securities and may be maintained in a margin account. The margin data may include the margin of one or more clearing firms or data that may be used to determine the portfolio margin of a defaulting clearing firm or non-defaulting clearing firm. For example, the margin data may include the data needed to apply a margin model, such as the ISDA margin model or a multi-factor margin model, to obtain the portfolio margin of one or more clearing firms. The multi-factor margin model may be the multi-factor margin model presented in U.S. application Ser. No. ______ [Attorney Docket No. 4672-735] ______, which was filed on ______, and is incorporated in entirety by reference.

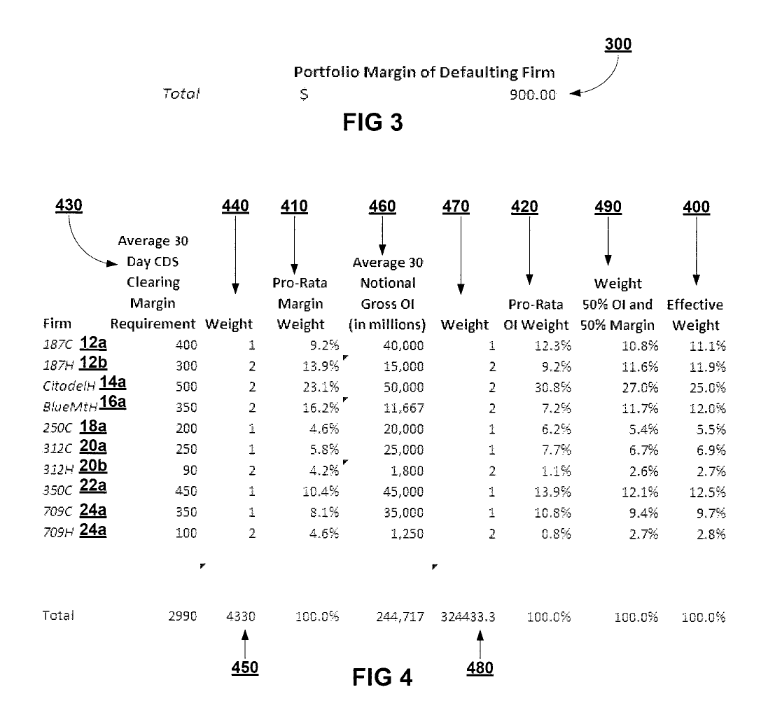

The processor 210 may be operable to determine a portfolio margin of the defaulting firm using margin data obtained via the input 200. The portfolio margin of the defaulting firm may be referred to as the defaulting margin. In the illustration above, as shown in FIG. 3, the portfolio margin of clearing firm 26a, which may be referred to as the defaulting margin 300, may be $900.00. The defaulting margin 300 may be determined by applying a margin model.

As shown in FIG. 4, the processor 210 may be operable to determine a total weight 400 for each non-defaulting clearing firm 12, 14, 16, 18, 20, 22, 24. The total weight 400 may be determined based on a margin weight 410 and open interest weight 420. As used herein, the margin weight 410 is the clearing firm's margin relative to all or some of the margin of all the non-defaulting firms 12, 14, 16, 18, 20, 22, 24. The open interest weight 420 is the clearing firm's open interest relative to the entire open interest of all the firms. Open interest may be an outstanding position that is not closed. The position may be a buy position or sell position.

The margin weight 410 may be determined based on a margin requirement 430 and margin weighting 440. The margin requirement 430 may be the margin required to maintain that account. For example, in order to maintain the customer account 12a, the clearing firm 12 may be required to maintain $400 in a margin account with the exchange. The margin requirement 430 may be determined based on the credit default swap portfolio (e.g., the size of the CDS portfolio) and a margin model. The account weight 440 may be a qualitative or quantitative weight. The account weight 440 may be determined relative to the other accounts. For example, as shown in FIG. 4, the account weight 440 may be determined based on whether the account is a house account or customer account. In order to give more weight to a house account, the house account weight may be “2” and the customer account weight may be “1.” In other embodiments, this may be switched. Alternatively, the house account weight may be the same as the customer account weight. The account weight 440 may be set by an exchange, clearing firm, or other operator.

Once the margin requirement 430 and account weight 440 for each clearing firm account is determined, the processor 210 may determine the weighted margin 450. The weighted margin 450 may be determined based on the margin requirement 430 and account weight 440 for each clearing firm. The weighted margin 450 may be determined using Equation 1.

WM 450=(MR₁*AW₁)+(MR₂*AW₂) . . . (MRₙ*Awₙ) Equation 1

In Equation 1, MR₁ is the margin requirement for a first account and AW₁ is the account weight for the first account. For example, in FIG. 4, the margin requirement 430 for account 12a may be 400 and the account weight 440 for account 12a is “1.” The weighted margin for account 12a may be determined by multiplying “400” and “1.” The weighted margin 450 may be determined by summing the weighted margins for each of the clearing firm accounts.

The margin weight 410 may be determined for each account may be determined based on the weighted margin 450 and the weighted margins for each of the accounts. For example, as discussed above, the weighted margin for account 12a is “400” and the weighted margin 450 is “4330.” The processor 210 may determine the percentage of the weighted margin 450 of the weighted margin for account 12a. In this example, “400” is 9.2% of “4330.” The margin weight for account 12a is 9.2%. The processor 210 may determine the margin weight for each of the accounts.

The open interest weight 420 may be determined based on the open interest of each clearing firm 460 and the open interest weighting 470. The open interest 460 may be the open interest for an account. Open interest may be an outstanding position that is not closed. The position may be a buy position or sell position. The open interest may be gross notional open interest. Gross notional of open interest is the sum of the credit default swap open interest for a particular firm without netting any positions. For example, as shown in FIG. 4, the open interest for account 12a may be 40,000,000,000 buying protection or selling protection. The account weight 470 may be a qualitative or quantitative weight. The account weight 470 may be determined relative to the other accounts. For example, as shown in FIG. 4, the account weight 470 may be determined based on whether the account is a house account or customer account. In order to give more weight to a house account, the house account weight may be “2” and the customer account weight may be “1.” In other embodiments, this may be switched. Alternatively, the house account weight may be the same as the customer account weight. The account weight 470 may be set by an exchange, clearing firm, or other operator.

The processor 210 may determine the weighted open interest 480. The weighted open interest 480 may be determined based on the open interest 460 and account weight 470. For example, the weighted open interest 480 may be determined using Equation 2.

WOI 480=(OI₁*AW₁)+(OI₂*AW₂) . . . (i OIₙ*OIₙ) Equation 2

In Equation 1, OI₁ is the open interest for the first account and AW₁ is the account weight for the first account. For example, in FIG. 4, the open interest 460 for account 12a may be 40,000,000,000 and the account weight 470 for account 12a is “1.” The weighted open interest for account 12a may be determined by multiplying “40,000,000,000” and “1.” The weighted margin 480 may be determined by summing the weighted margins for each of the clearing firm accounts. In this example, the weighted open interest 480 may be “324,433,300,000.”

The open interest weight 420 may be determined based on the weighted open interest 480 and the weighted margins for each of the accounts. For example, as discussed above, the weighted margin for account 12a is “40,000,000,000” and the weighted open interest 480 is “324,433,300,000.” The processor 210 may determine the percentage of the weighted margin 480 of the weighted margin for account 12a. In this example, “40,000,000,000” is 12.3% of “324,433,300,000.” The open interest weight 420 for account 12a is 9.2%. The processor 210 may determine the open interest weight for each of the accounts.

The average weight 490 may be the average of the margin weight 410 and the open interest weight 420. For example, the average of the margin weight 410 and the operating income weight 420 may be determined using Equation 3.

AW 490=[MW 410+OI Weight 420]/2 Equation 3

The total weight 400 for each non-defaulting clearing firm may be determined using the margin weight 410, open interest weight 420, and one or more scaling factors. The scaling factors may be used to scale the margin weight 410 and open interest weight 420. The scaling factors may be qualitative or quantitative scaling factors. The scaling factors may be used to adjust the margin weight 410 and open interest weight 420 relative to each other. The scaling factors may be set by an exchange, clearing firm, or other operator and may remain constant or change over time. The total weight 400 may be determined using Equation 4.

TW 400=(1+SF)*AW 490 Equation 4

In equation 4, the scaling factor SF is used in order to weight open interest or margin higher to produce the effective weight. The decision of whether to tilt (i.e., scale) the allocation weights more towards open interest than margin or vice versa depends on the risk management team's decision. The scaling factor SF may be based the depth of the credit default swap order book, the amount of credit default swap margin paid, and the amount of capital and security deposit that the credit default swap clearing firms have.

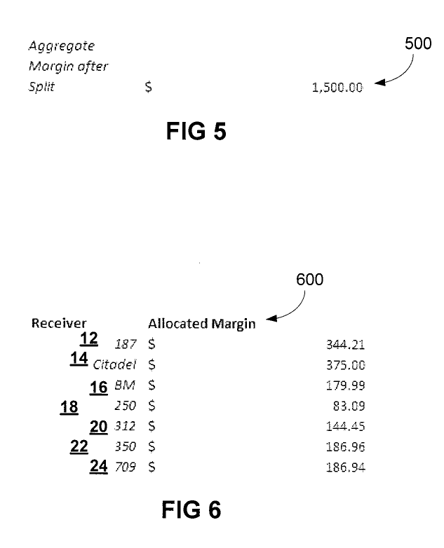

The processor 210 may determine the margin allocated to each clearing firm, which may be referred to as the clearing firm's allocated margin. The clearing firm's allocated margin may be determined based on the total weight 400 for the clearing firms and the aggregated margin. As shown in FIG. 5, the aggregated margin may be the sum of all the margins after the defaulting firm's credit default swap portfolio is allocated to all the clearing firms (i.e., is split). In the illustration above, as shown in FIG. 5, the aggregate margin 500 for the clearing firm is $1500. As shown in FIG. 6, the clearing firm's allocated margin 600 may be determined based on the aggregate margin 500 and the total weight 400 of FIG. 4. Accordingly, the allocated margin 600 for clearing firm 12 may be determined based on the aggregate margin 500 and the total weight 400 for clearing firm 12a and the total weight for clearing firm 12b. More specifically, the allocated margin 600 for clearing firm 12 may be determined using Equation 5.

AM 600=TW_{Rx}*AM 500 Equation 5

In Equation 5, “TW_{Rx}” is the sum of the total weight for the clearing firm's accounts. For example, in the illustration above, the TW_{Rx} for clearing firm 12 is 23% (i.e., 11.1%+11.9%) for clearing firm 12a and clearing firm 12b. As a result, the allocated margin 600 for clearing firm 12 is $344.21.

The allocated margin indicates the amount of the defaulting margin that the clearing firm is responsible for absorbing. The credit default swap positions that equate to the margin are moved from the defaulting firm's portfolio to the receiving clearing firm's portfolio. This may be performed automatically (e.g., without user interaction), for example, using the system 100 or manually by an authorized user.

Referring back to FIG. 2, the memory 220 may be computer readable storage media. The computer readable storage media may include various types of volatile and non-volatile storage media, including, but not limited to, random access memory, read-only memory, programmable read-only memory, electrically programmable read-only memory, electrically erasable read-only memory, flash memory, magnetic tape or disk, optical media and the like. The memory 220 may be a single device or a combination of devices. The memory 220 may be adjacent to, part of, networked with and/or remote from the processor.

Data representing instructions, executable by the processors, may be stored in the computer readable storage media. Logic encoded or embedded in one or more tangible media for execution is defined as the instructions that are executable by the programmed processor and that are provided on the computer-readable storage media, memories, or a combination thereof. The one or more processors may be programmed with and execute the instructions. The functions, acts, methods or tasks illustrated in the figures or described herein may be performed by the programmed processor executing the instructions stored in the memory. The functions, acts, methods or tasks are independent of the particular type of instructions set, storage media, processor or processing strategy and may be performed by software, hardware, integrated circuits, firmware, micro-code and the like, operating alone or in combination. The instructions are for implementing the processes, techniques, methods, or acts described herein.

The display 230 is a cathode ray tube (CRT), liquid crystal display (LCD), plasma, projector, monitor, printer, or other output device for showing data. The display 16 is operable to display an image. The image may be of an allocated margin image, chart, graph, value, or other allocated margin information. Allocated margin images, charts, graphs, values, or other allocated margin information may be used to represent an allocated margin for a clearing firm or clearing firm account. In an alternative embodiment, the processor 210 may be operable to output an allocated margin image, chart, graph, text, audio, value, or other information to other devices, such as speakers, memory, networks, or other interfaces.

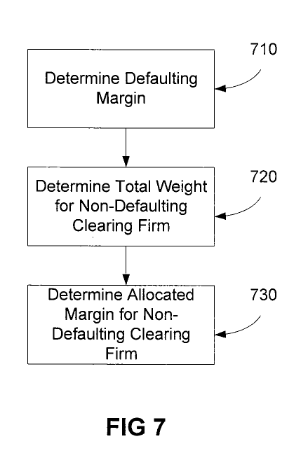

FIG. 7 illustrates one embodiment of a method 700 for determining an allocated margin of a credit default swap portfolio. The method 700 may include determining a defaulting margin 710; determining a total weight for non-defaulting clearing firm 720; and determining an allocated margin for the non-defaulting clearing firm as a function of the total weight and defaulting margin. The non-defaulting clearing firm may include one or more accounts having credit default swap portfolios. The allocated margin may be determined based on the margin and open interest of the one or more accounts. The acts may be performed in the order shown or a different order. For example, act 720 may be performed prior to act 710.

In act 710, an exchange computer system may determine a defaulting margin using a margin model. The exchange computer system may use information about a defaulting clearing firm's accounts with the margin model to determine the defaulting margin. Any margin model may be used. Alternatively, determining the defaulting margin may include receiving the defaulting margin, for example, via a network or storage device. The defaulting margin may be transmitted to the exchange computer system.

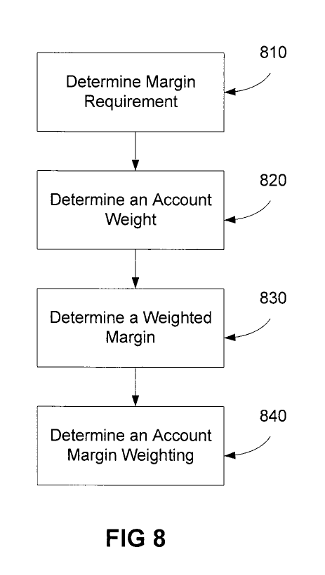

In act 720, the exchange computer system may determine a total weight for a non-defaulting clearing firm. Determining the total weight may include determining a margin weight and an open interest weight. FIG. 8 illustrates one embodiment of a method 800 for determining a margin weight. As shown in FIG. 8, the method 800 may include determining a margin requirement 810, account weight 820, weighted margin 830, and account margin weighting 840. The acts may be performed in the order shown or a different order. Determining a margin requirement 810 may include using a margin model. Margin data, for example, about a non-defaulting account, may be used with the margin model to determine the margin requirement. Determining the account weight 820 may include setting a weighting to properly weight the one or more non-defaulting accounts. For example, a house account may be weighted more or less than a customer account. The account weightings may be predetermined or dynamically determined. Determining the weighted margin 830 may include determining a weighted margin for each of the non-defaulting accounts and summing the weighted margins together. Determining the account margin weighting 840 may include determining a percentage of the weighted total margin for each individual, non-defaulting account, which may include dividing the weighted margin for an individual, non-defaulting account by the total weight margin.

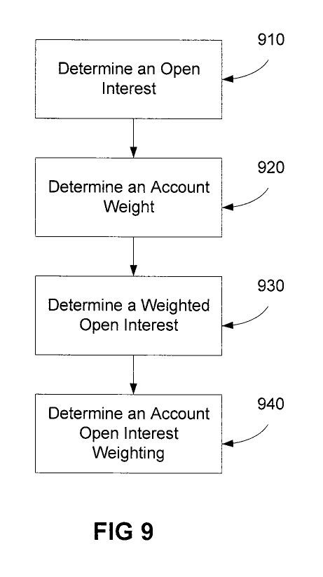

FIG. 9 illustrates one embodiment of a method 900 for determining an open interest weight. As shown in FIG. 9, the method 900 may include determining an open interest 910, account weight 920, weighted open interest 930, and account open interest weighting 840. The acts may be performed in the order shown or a different order. Determining an open interest 910 may include importing data about the account. Open interest data, for example, about a non-defaulting account, may be used to determine the margin requirement. Determining the account weight 920 may include setting a weighting to properly weight the one or more non-defaulting accounts. For example, a house account may be weighted more or less than a customer account. The account weight determined in act 920 may be the same or different than the account weight determined in act 820. The account weights may be predetermined or dynamically determined. Determining the weighted open interest 930 may include determining a weighted open interest for each of the non-defaulting accounts and summing (i.e., adding) the weighted open interests. Determining the account margin weighting 940 may include determining a percentage of the weighted total open interest for each individual, non-defaulting account, which may include dividing the weighted margin for an individual, non-defaulting account by the total weight open interest.

Referring back to FIG. 7, as shown in act 730, the exchange computer system may determine an allocated margin for the non-defaulting clearing firm as a function of the total weight and aggregated margin. Determining the allocated margin may include transferring or spreading the allocated margin for a non-defaulting clearing firm to the non-defaulting clearing firm's margin account. Transferring or spreading may include moving, updating, or otherwise making the non-defaulting clearing firm responsible for the allocated margin. Furthermore, determining the allocated margin may include notifying, for example, via email, account statement, etc., that the allocated margin was transferred or spread to the non-defaulting clearing firm's margin account.

Various improvements described herein may be used together or separately. Any form of data mining or searching may be used. Although illustrative embodiments have been described herein with reference to the accompanying drawings, it is to be understood that the invention is not limited to those precise embodiments, and that various other changes and modifications may be affected therein by one skilled in the art without departing from the scope or spirit of the invention.

1. A method for allocating margin of a defaulting firm:
determining, using a computer exchange system, a total weight for a non-defaulting clearing firm, the non-defaulting clearing firm maintaining credit default swap portfolios;
determining, using the computer exchange system, an aggregated margin; and
determining, using the computer exchange system, an allocated margin of the margin of the defaulting firm for the non-defaulting clearing firm as a function of the total weight and aggregated margin.

2. The method as claimed in claim 1, wherein determining the total weight includes determining an average weight for each of the accounts maintained by the non-defaulting clearing firm.

3. The method as claimed in claim 1, wherein determining the total weight includes determining a margin weight and an open interest weight.

4. The method as claimed in claim 1, wherein determining the margin weight includes determining the margin weight as a function of a margin requirement and an account margin weight and determining the open interest weight includes determining the open interest weight as a function of open interest and an account open interest weight, the margin requirement being the margin required to maintain the credit default swap and the open interest being the interest that has not been closed.

5. The method as claimed in claim 4, further comprising scaling the margin weight and open interest weight.

6. The method as claimed in claim 1, wherein determining the aggregated margin includes a sum of each margin requirement after the defaulting firm's credit default swap portfolio is allocated.

7. The method as claimed in claim 1, wherein determining the allocated margin includes outputting an allocated margin image to a display device.

8. The method as claimed in claim 1, further comprising transferring the allocated margin to the non-defaulting clearing firms margin account.

9. An exchange system comprising:
a processor; and
a memory coupled with the processor, the memory including instructions that are operable to be executed to:
determine a total weight for a non-defaulting clearing firm, the non-defaulting clearing firm maintaining credit default swap portfolios;
determine, using the computer exchange system, an aggregated margin; and
determine an allocated margin of the margin of the defaulting firm for the non-defaulting clearing firm as a function of the total weight and aggregated margin.

10. The exchange system as claimed in claim 9, wherein the memory comprises instructions that may be executed to determine an average weight for each of the accounts maintained by the non-defaulting clearing firm.

11. The exchange system as claimed in claim 9, wherein the memory comprises instructions that may be executed to determine a margin weight and an open interest weight.

12. The exchange system as claimed in claim 9, wherein the memory comprises instructions that may be executed to determine the margin weight as a function of a margin requirement and an account margin weight and determine the open interest weight as a function of open interest and an account open interest weight, the margin requirement being the margin required to maintain the credit default swap and the open interest being the interest that has not been closed.

13. The exchange system as claimed in claim 9, wherein the memory comprises instructions that may be executed to scale the margin weight and open interest weight.

14. The exchange system as claimed in claim 12, wherein the memory comprises instructions that may be executed to determine the aggregated margin, the aggregated margin being a sum of each margin requirement after the defaulting firm's credit default swap portfolio is allocated.

15. The exchange system as claimed in claim 9, wherein the memory comprises instructions that may be executed to output an allocated margin image to a display device.

16. A system for allocating margin for a credit default swap portfolio, the system comprising:
a means for determining a total weight for a non-defaulting clearing firm, the non-defaulting clearing firm maintaining credit default swap portfolios;
a means for determining an aggregated margin; and
a means for determining an allocated margin of the margin of the defaulting firm for the non-defaulting clearing firm as a function of the total weight and aggregated margin.

17. A method for allocating margin of a credit default swap portfolio, the method comprising:
identifying a credit default swap portfolio maintained by a defaulting clearing firm,
determining a defaulting margin for the portfolio, the defaulting margin being determined using a margin model; and
allocating the defaulting margin to one or more non-defaulting clearing firms based on account margins for each of the non-defaulting clearing firms.

18. The method as claimed in claim 17, wherein the margin model is a multi-factor margin model.

19. The method as claimed in claim 17, wherein allocating the defaulting margin includes dividing the defaulting margin and spreading the defaulting margin to margin accounts of the non-defaulting clearing firms.

20. The method as claimed in claim 19, further comprising notifying the clearing firms of the spreading.
